(19) United States
(12) Patent Application Publication
(10) Pub. No.: US 2013/0211878 A1
(43) Pub. Date: Aug. 15, 2013

(54) ESTIMATING ELASTICITY AND INVENTORY EFFECT FOR RETAIL PRICING AND FORECASTING

(71) Applicant: Oracle International Corporation, (US)

(72) Inventors: Alex KUSHKULEY, Acton, MA (US); Su-Ming WU, Waltham, MA (US)

(73) Assignee: ORACLE INTERNATIONAL CORPORATION, Redwood Shores, CA (US)

(21) Appl. No.: 13/686,138

(22) Filed: Nov. 27, 2012

Related U.S. Application Data
(60) Provisional application No. 61/598,028, filed on Feb. 13, 2012.

(51) Int. Cl. G06Q 30/02

(52) U.S. Cl. CPC G06Q 30/0202
USPC 705/7.31

(57) ABSTRACT

A system that estimates elasticity and inventory effect for a product pricing or forecasting system receives a sales condition relationship for an item at a store, the relationship comprising an elasticity parameter, an inventory effect parameter and a sales constant. The system receives a demand model for sales of the item in terms of the elasticity parameter and the inventory effect parameter and a base demand for the item selling at the store. The system estimates the sales constant, the estimating comprising generating a theta parameter by taking logarithms of the sales condition relationship. The system uses linear regression to estimate a logarithm of the sales constant and a value of the theta parameter. The system determines a relationship between the elasticity parameter and the inventory effect parameter based on the value of the theta parameter.

### CROSS REFERENCE TO RELATED APPLICATIONS

This application claims priority of Provisional Application Ser. No. 61/598,028, filed on Feb. 13, 2012, the contents of which is hereby incorporated by reference.

### FIELD

One embodiment is directed generally to a computer system that forecasts retail sales or provides pricing, and in particular to estimating elastic and inventory effect for a computer system that forecasts retail sales or provides pricing.

### BACKGROUND INFORMATION

A typical need for retail stores is generating a week-by-week forecast of sales units for merchandise (i.e., how many units of a particular piece of merchandise sells in a particular week). The sales units of merchandise in a given week is affected by many factors, such as seasonal factors, whether a discount has been applied to the merchandise during the week, at what point in the lifecycle of the merchandise the week falls, etc. One common approach to forecasting weekly sales units involves building a “causal demand model” for the merchandise. This model is a mathematical model that describes weekly sales units in terms of factors such as the ones listed above. The factors are known as the “demand variables” for the demand model.

The model specifies mathematically how the demand variables affect sales units. For example, if the amount of discount is a demand variable in a model, the model may specify that a 50% price cut results in a 4-fold increase in sales units. With a causal demand model, it is then possible to forecast sales units by specifying the future values of the demand variables. For example, the retailer might know that next season it will be running a 40% price cut during some weeks. The demand model will then forecast sales units for those weeks accounting for the 40% price cut.

Further, for a retailer or any seller of products, at some point during the selling cycle a determination will likely need to be made on when to markdown the price of a product, and how much of a markdown to take. Price markdowns can be an essential part of the merchandise item lifecycle pricing. A typical retailer has between 20% and 50% of the items marked down (i.e., permanently discounted) and generates about 30-40% of the revenue at marked-down prices.

A determination of an optimized pricing markdown maximizes the revenue by taking into account inventory constraints and demand dependence on time period, price and inventory effects. An optimized markdown can bring inventory to a desired level, not only during the full-price selling period, but also during price-break sales, and maximize total gross margin dollars over the entire product lifecycle.

Both sales forecasting and pricing markdown optimization utilize the demand model. For typical retail computer systems, the demand model requires an estimation of elasticity and inventory effect variables.

### SUMMARY

One embodiment is a system that estimates elasticity and inventory effect for a product pricing or forecasting system. The system receives a sales condition relationship for an item at a store, the relationship comprising an elasticity parameter, an inventory effect parameter and a sales constant. The system receives a demand model for sales of the item in terms of the elasticity parameter and the inventory effect parameter and a base demand for the item selling at the store. The system estimates the sales constant, the estimating comprising generating a theta parameter by taking logarithms of the sales condition relationship. The system uses linear regression to estimate a logarithm of the sales constant and a value of the theta parameter. The system determines a relationship between the elasticity parameter and the inventory effect parameter based on the value of the theta parameter.

### BRIEF DESCRIPTION OF THE DRAWINGS

FIG. 1 is a block diagram of a computer system that can implement an embodiment of the present invention.

FIG. 2 is a flow diagram of the functionality of the elasticity and inventory effect estimation module of FIG. 1 when determining an estimation of elasticity and inventor effect in accordance with one embodiment.

### DETAILED DESCRIPTION

One embodiment is a retail product pricing and forecasting system that estimates the elasticity and inventory effect variables/parameters by determining a dependency between elasticity and inventory. Therefore, only one of these parameters needs to be estimated, and the determined dependency can be used to estimate the other parameter. From the estimates, product pricing and forecasting can be determined.

As discussed above, in order for the causal demand model to be of use in forecasting sales units or in markdown optimization, it is necessary to determine the relationship of the demand variables to the sales units (this relationship is referred to as the demand parameter associated with the demand variable). In the example given above, a 50% price cut results in a 4-fold increase in sales units. In order to determine that it is a 4-fold increase and not a 5-fold or a 4.5-fold increase, it is necessary to determine the relationship between the discount demand variable and sales units. The demand parameter is determined by examining historical data containing price cuts for the merchandise itself, or for similar merchandise if the merchandise itself is new. However, as noted above, the demand model typically consists of several demand variables because the amount of units sold must depend on several variables. These several demand variables apply simultaneously. For example, a retailer may have performed a price cut during the summer for summer merchandise, in which case at least two demand variables are operating—the price cut, and the increase in sales because it is the summer. It is necessary to disentangle the effect of the increase in sales units due to the price cut vs. the effect due to the summer. The known approach of performing this disentangling is through a statistical technique called “regression.”

However, this known approach to applying regression has typically produced values for elasticity that are clearly incorrect, due to the co-linearity between elasticity and other parameters, in particular the parameter for inventory effect. For example, in many cases, the value obtained for elasticity is the wrong sign. Because the elasticity is incorrect, forecasts and markdown optimizations based on the incorrect value will be incorrect as well.

For pricing determinations, in one embodiment pricing markdown can be determined by solving a “markdown optimization problem.” The objective of the markdown optimization problem can be to find a monotonically decreasing sequence of merchandise prices that maximizes the revenue by taking into account inventory constraints and demand dependence on time period, price and inventory effects.

The mathematical formulation of the markdown optimization problem can be defined in one embodiment as:

$$max {\sum }_{t = 1}^{T} {p}_{t} {s}_{t}$$

$$subject to \text{:}$$

$${s}_{t} \leq {d}_{t} ( {I}_{0} , {p}_{1} , … , {p}_{t} , {d}_{1} , … , {t}_{t - 1} ) ∀ t = 1 , … , T$$

$${s}_{t} \leq {I}_{t - 1}$$

$${I}_{t} = {I}_{t - 1} - {s}_{t}$$

where:

T is the length of the markdown period, usually measured in weeks;

sₜ is the sales volume in period t;

pₜ is the sales price at period t, which is the decision variable;

Iₜ is the inventory level at the end of time period t, I₀ is given as part of the input; and

dₜ( . . . ) is the demand, which in general is a function of past and present price settings, initial inventory, and demand in previous periods. The objective of the optimization problem is to maximize the total revenue.

In one known pricing markdown optimizer, “Retail Markdown Optimization (MDO)”, version 13.2, from Oracle Corp., a number of simplifying assumptions are made regarding the demand to solve the markdown optimization problem, which results in the following expression for the demand function:

d(t, p, I)=k dₚ(p)d_{I}(I)s(t)δ(t)=k(p/p_{f})^{γ}(I/I_{c})^{α}s(t)δ(t);

where the components of the demand function are as follows:

Price Effect, dₚ(p): captures the sensitivity of demand to price changes. It is modeled as an isoelastic function of price p with constant elasticity γ<−1, dₚ(p)=(p/p_{f})^{γ} where p_{f} is the full price of the item;

Inventory Effect, d_{I}(I): also known as the “broken-assortment effect”, which occurs when willing-to-pay customers cannot find their sizes/colors. It is modeled as a power function of on-hand inventory I, d_{I}(I)=(I/I_{c})^{α}, where I_{c} is the critical inventory of the item;

Seasonality, s(t): seasonal variation of demand due to holidays and seasons of the year; shared by similar items;

Base demand, k: the scaling coefficient expressing the overall strength of the demand; and

Random fluctuations, δ(t): random process expressing the stochastic nature of the consumer demand.

Further, as previously discussed, the demand model parameters for the markdown optimization or for sales forecasting are fitted by estimating base demand, k, price elasticity, γ, and inventory effect power, α, via regression on multiple sales data points with known price, inventory and seasonality.

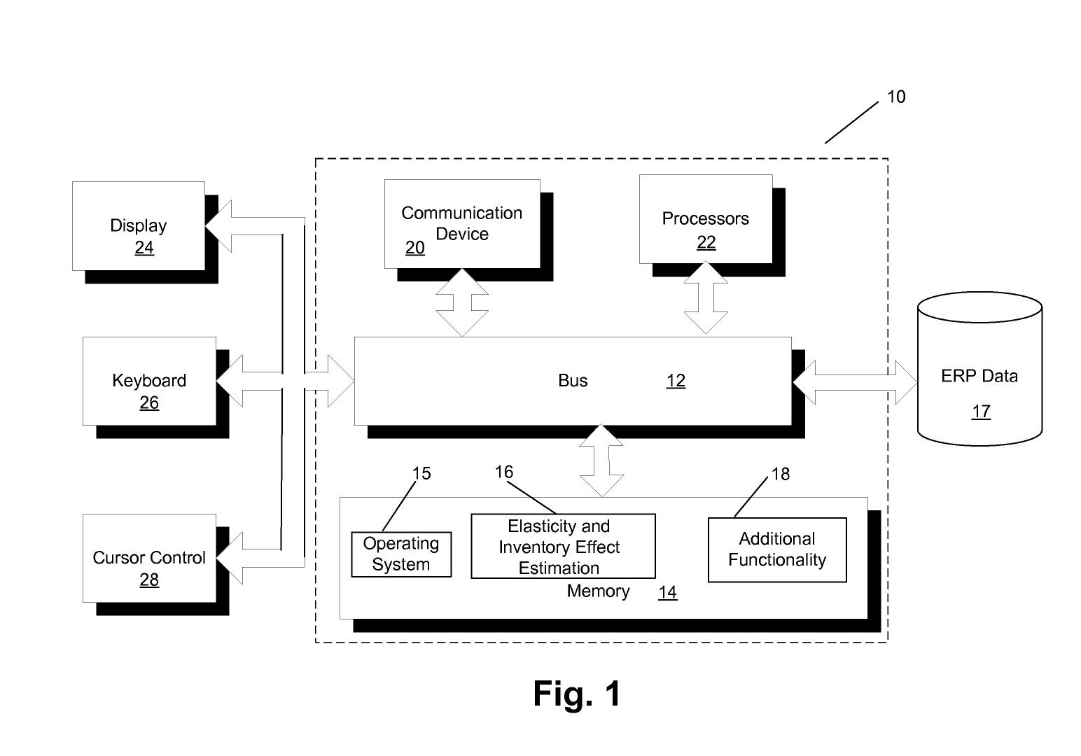

FIG. 1 is a block diagram of a computer system 10 that can implement an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include an elasticity and inventory effect estimation module 16 that estimates elasticity and inventory effect for use, for example, in retail product pricing and sales forecasting. System 10 can be part of a larger system, such as “Retail Demand Forecasting” from Oracle Corp., which can utilize the elasticity and inventory effect estimations for sales forecasting, or “Retail Markdown Optimization” from Oracle Corp., which can utilize the elasticity and inventory effect estimations for pricing/markdown optimization, or part of an enterprise resource planning (“ERP”) system. Therefore, system 10 will typically include one or more additional functional modules 18 to include the additional functionality. A database 17 is coupled to bus 12 to provide centralized storage for modules 16 and 18 and store pricing data and ERP data such as inventory information, etc.

In one embodiment, instead of applying the typical regression approaches to estimate elasticity and inventory effect, a dependency is determined between elasticity and inventory effect. The elasticity parameter is then determined in terms of the inventory effect parameter, thus reducing by one the number of parameters needed to estimate. The inventory effect parameters are then estimated, and the value for the elasticity parameters is then determined using the determined dependency between the two parameters.

In one embodiment, the sales forecast model provides weekly sales units of an item “M” selling at a particular store “A” in terms of several variables. The price markdown model uses many of the same variables. As discussed above, these variables or parameters include the “base demand” “K” of M at A, the “elasticity” γ (“gamma”) of M at A, the “inventory effect” parameter α (“alpha”) of M at A, and the seasonality σₜ (“sigma”) of M at A.

The price effect or elasticity parameter is the relationship of price to sales units. The inventory effect is the relationship of inventory to sales units. Each of these relationships is characterized by a parameter that is derived from historical sales data for M selling at A. The historical sales data includes not just the unit sales of M but also the historical prices and the historical inventory levels of M at A.

As discussed, known methods of estimating elasticity and inventory effect using straight-forward regression frequently produces values that are clearly incorrect. In order to avoid these problems, one embodiment estimates elasticity and inventory effect as follows:

Elasticity/alpha and inventory effect/gamma, whatever their values, are related as shown in the following under ideal sales conditions:

I^{α}p^{γ+1}=C (Equation 1)

Where C is some constant, determined by the sales data of M. The variable I represents inventory levels, and p represents prices. Equation 1 indicates that the retailer, under ideal conditions, will compensate for inventory increases and decreases by increasing or decreasing prices in order to keep revenue for item M at substantially a constant, maximum level. The sales data in question is assumed not to have large promotions in it. If the sales data contains large promotions, these should be filtered out of the data before using the data in the regressions described below.

Equation 1 above is in general disclosed in U.S. patent application Ser. No. 13/235,919, filed on Sep. 9, 2011, and entitled “Pricing Markdown Optimization System” (hereinafter, the “Markdown Patent”), the disclosure of which is herein incorporated by reference. In the Markdown Patent, functions for optimal price “p(t)” and inventory “I(t)” are disclosed. These functions can be substituted for “I” and “p” of Equation 1, which results in a constant because the numerator of the exponent becomes: γ+1−αθ=γ+1−(γ+1)=0).

As disclosed in the Markdown Patent, for a pricing markdown situation, it can be assumed that demand follows the following model for sales units:

S=K·I^{α}·P^{γ} (Equation 2)

Where S is sales units of M selling at A, and K is the “base demand” of M selling at A. Equation 2 differs from the model for sales units disclosed in the Markdown Patent because it does not take into account seasonality or random fluctuation factors. The optimal price curve is the one which maintains the relationship in Equation 1 (i.e., keeps the revenue rate constant while lowering prices). An optimal value of C in Equation 1 can be expressed as p₀I₀, where p₀ is the “initial price” of the item (i.e., the item price at the beginning of the markdown period), and I₀ is the “initial inventory,” (i.e., the inventory of the item at the beginning of the markdown period).

As an example of the use of Equation 1 for price markdowns, consider fashion retailers that perform markdowns at the end of a selling season in order to get rid of inventory. The retailer must clear as much of the inventory as possible before the season ends, while obtaining as much revenue as possible from the remaining inventory. During this period, no new inventory comes into the stores, since the season is nearing the end and the retailer is simply trying to get rid of remaining inventory. If the retailer wants to perform the markdown optimally, that is, maximize the revenue obtainable from selling the remaining inventory, the retailer should follow the prices given by the price curve disclosed in the Markdown Patent. According to that price curve, the retailer will keep the revenue rate of each item constant while lowering prices.

Retailers who run their business reasonably during markdowns will approximately follow Equation 1 even without necessarily being aware of Equation 1 (assuming their demand follows Equation 2). During markdowns, they already know to decrease prices in order to maintain the revenue rate. In fact, as inventory decreases down to 0, the retailer decreases prices more and more, which is consistent with Equation 1 (where as I decreases, p must also decrease to maintain C, assuming that alpha >0 and gamma <−1). Therefore, from direct historical experience, the retailer knows how much to decrease prices for an item in order to maintain a constant revenue rate for it, and thus the retailer is following Equation 1, although perhaps unknowingly.

However, the retailer likely does not know the optimal value of C of Equation 1 for each item. The retailer may not have chosen the correct constant revenue rate. That is, the retailer may behave according to Equation 1, but uses a value for C that does not in fact give the largest total revenue because they are not using the system disclosed in the Markdown Patent.

In contrast, embodiments of the present invention depend on the retailer behaving according to Equation 1 for some C, but not necessarily the optimal value for C. As long as the retailer is behaving according to Equation 1 for some C, embodiments can determine the value of C that the retailer is using by examining the retailer's historical sales data. Consequently, once the value of C is determined, embodiments generate a useful and viable relationship between alpha and gamma.

In general, embodiments determine C of Equation 1 using regression against the retailer's historical sales and inventory data, because the retailer more than likely did not follow Equation 1 exactly. Further, some embodiments do not obtain an individual C for each item-store combination, but rather perform the regression using a collection of data that groups similar items and similar stores together, in which case is a single C is derived for all the items and stored in the grouping, as per known statistical techniques.

Further, for the data, one embodiment uses only those segments of historical sales/price data where the retailer was in the process of performing inventory clearing markdowns, typically at the end of a selling season for fashion retailers. During such segments, no new inventory is sent to stores, which is one basic characterization of such markdown segments. In one embodiment, the retailer's help can be used in identifying such segments.

Further, embodiments should avoid data from weeks where the retailer performed large promotions. It is possible for a retailer to hold a promotion during a markdown period, and data from those weeks should be avoided unless the promotion is a long one and encompasses practically the entire markdown period.

In one embodiment, Equation 1 is used to estimate C by taking logarithms of the equation (with some slight re-arranging, and using logarithm C to denote

$$\frac{log C}{1 + γ} ) \text{:}$$

$$log p = log C - \frac{α}{1 + γ} log I$$

$$log p = log C - \frac{1}{θ} log I$$

As shown,

$$\frac{1 + γ}{α}$$

has been replaced by the single parameter theta θ. Simple linear regression can now be used to estimate logarithm C and

$$\frac{1}{θ} .$$

Therefore, embodiments perform simple linear regression to obtain values for logarithm C and theta.

Having a value for theta now gives a relationship between alpha and gamma as follows:

αθ−1=γ (Equation 3)

Based on Equation 2 above, embodiments use the relationship between alpha and gamma of Equation 3 to eliminate gamma from the regression. Therefore, embodiments avoid the need to estimate both alpha and gamma simultaneously, as is done in prior systems, which can lead to inaccuracy in alpha and gamma.

In order to eliminate gamma, logarithms are taken of Equation 2 in order to transform the demand model into a log-linear form in order to perform regression, and αθ−1 is substituted for gamma:

log K+α log I+γ log P=log S

log K+α(log I+θ log P)−log P=log S

log K+α(log I+θ log P)=log S−log P

This is now a linear regression in only logarithm K and alpha (since theta is known). Once alpha is determined through standard linear regression, gamma is determined by

γ=αθ−1.

In another embodiment, for a price forecasting system disclosed in U.S. patent application Ser. No. 13/101,276, filed on May 5, 2011, and entitled “Scalable Regression for Retail Panel Data” (the disclosure of which is herein incorporated by reference), demand is expressed as a two-variable linear regression in alpha and gamma:

α log P+γ log I=log S (Equation 4)

As with other embodiments, this system requires an estimate of alpha and gamma. In accordance with embodiments of the present invention, Equation 4 is transformed into a single-parameter linear regression to solve for alpha:

α log P+(αθ−1)log I=log S

α(log P+θ log I)=log S+log I

After alpha is known through linear regression, gamma can be solved as follows:

γ=αθ−1.

Once alpha and gamma are known, K can be found via another single-parameter linear regression using Equation 2 disclosed above.

Knowing K, alpha and gamma, seasonality can now be determined using known methods. One such method is disclosed in U.S. patent application Ser. No. 13/101,276.

With K, alpha, gamma, and seasonality now known, these parameters can be given to a forecasting system to produce a sales forecast for sales of M at store A. For example, the parameters can be given to the sales forecast system disclosed in U.S. patent application Ser. No. 13/101,276.

The parameters can also be used as the inputs to a price markdown optimization system, such as the system disclosed in U.S. patent application Ser. No. 13/645,727, filed on Oct. 5, 2012, and entitled “Retail Product Pricing Markdown System” (the disclosure of which is herein incorporated by reference). Therefore, the estimates combined with the price markdown optimization system can provide retailers with recommendations on improved pricing and inventory management.

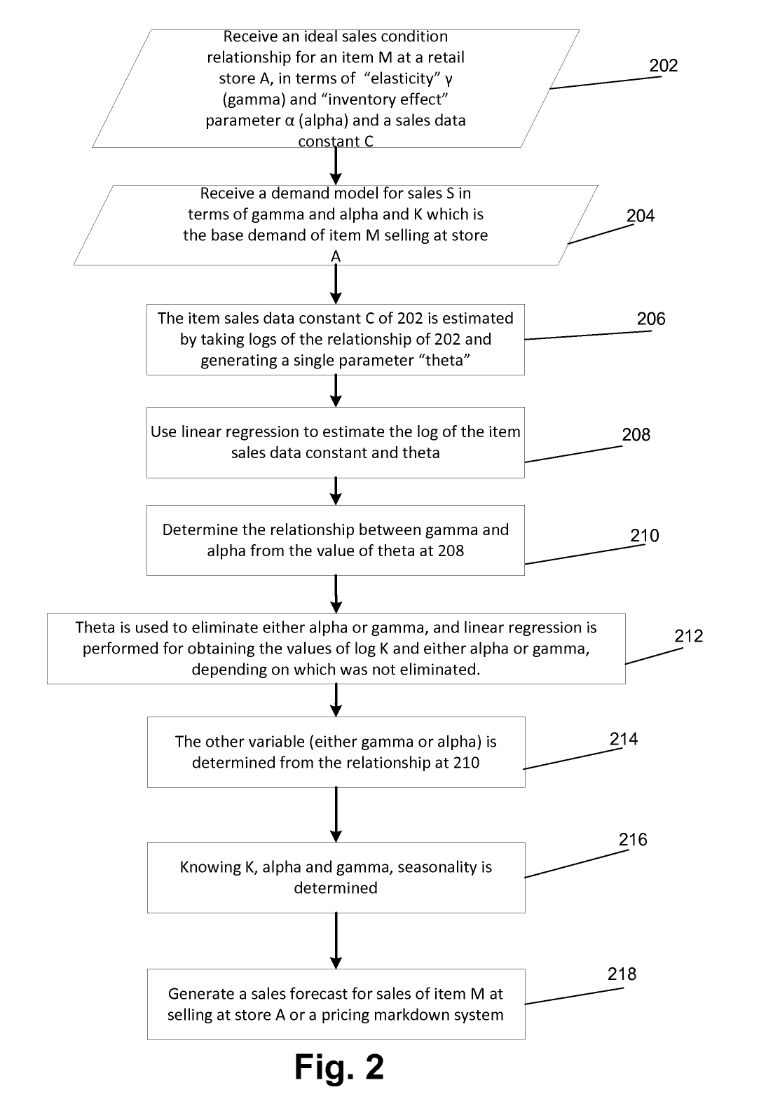

FIG. 2 is a flow diagram of the functionality of elasticity and inventory effect estimation module 16 of FIG. 1 when determining an estimation of elasticity and inventory effect in accordance with one embodiment. In one embodiment, the functionality of the flow diagram of FIG. 2 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 202, the ideal sales condition relationship for an item M at a retail store A, in terms of “elasticity” γ (gamma) and “inventory effect” parameter α (alpha) is received. In one embodiment, the relationship is I^{α}p^{γ+1}=C. The relationship includes a constant (e.g., “C”) determined by the historical sales data of M (an “item sales data constant”).

At 204, the demand model for sales S in terms of gamma and alpha is received. In one embodiment, the demand model is S=K·I^{α}·P^{γ}, where K is the base demand of item M selling at store A.

At 206, the item sales data constant C of 202 is estimated by taking logarithms of the sales condition relationship of 202 (i.e., Equation 1 above) and generating a single parameter “theta” θ to represent

$$\frac{1 + γ}{α} .$$

At 208, linear regression is used to estimate the logarithm of the item sales data constant and theta.

At 210, the value of theta is used to provide a relationship between gamma and alpha.

At 212, theta is used to eliminate either alpha or gamma, and linear regression is performed for obtaining the values of logarithm K and either alpha or gamma, depending on which was not eliminated. The regression can be a linear regression since the demand model now includes only a single variable.

At 214, the other variable (either gamma or alpha) is determined from the relationship at 210.

At 216, knowing K (from 212), alpha (from 212) and gamma (from 214), seasonality is determined.

At 218, a sales forecast is produced for sales of item M at selling at store A. In another embodiment, the estimates can be used to determine pricing.

As disclosed, embodiments provide estimates for elasticity and inventory effect variables/parameters that can be used for a retail product pricing and forecasting system. The estimates are generated by determining a dependency between elasticity and inventory. Therefore, only one of these parameters needs to be estimated, and the determined dependency can be used to estimate the other parameter. From the estimates, product pricing and forecasting can be determined. The estimates can be further used for any other retail system that relies on a demand model based on alpha and gamma.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer-readable medium having instructions stored thereon that, when executed by a processor, cause the processor to estimate elasticity and inventory effect, the estimating comprising:
receiving a sales condition relationship for an item at a store, the relationship comprising an elasticity parameter, an inventory effect parameter and a sales constant;
receiving a demand model for sales of the item in terms of the elasticity parameter and the inventory effect parameter and a base demand for the item selling at the store;
estimating the sales constant, the estimating comprising generating a theta parameter by taking logarithms of the sales condition relationship;
using linear regression to estimate a logarithm of the sales constant and a value of the theta parameter; and
determining a relationship between the elasticity parameter and the inventory effect parameter based on the value of the theta parameter.

2. The computer-readable medium of claim 1, the estimating further comprising:
eliminating either the elasticity parameter or the inventory effect parameter from the demand model based on the value of theta to generate a single variable demand model; and
using a single parameter linear regression to determine the base demand and to solve for either the elasticity parameter or the inventory effect parameter in the single variable demand model.

3. The computer-readable medium of claim 2, the estimating further comprising:
using the determined relationship between the elasticity parameter and the inventory effect parameter to solve for either the elasticity parameter or the inventory effect parameter.

4. The computer-readable medium of claim 3, the estimating further comprising:
determining a seasonality parameter based on the determined base demand, the determined elasticity parameter and the determined inventory effect parameter.

5. The computer-readable medium of claim 4, further comprising determining a sales forecast for sales of the item selling at the store based on the determined seasonality parameter, the determined base demand, the determined elasticity parameter and the determined inventory effect parameter.

6. The computer-readable medium of claim 4, further comprising determining a price markdown schedule for sales of the item selling at the store based on the determined seasonality parameter, the determined base demand, the determined elasticity parameter and the determined inventory effect parameter.

7. The computer-readable medium of claim 1, wherein the sales condition relationship comprises:
I^{α}p^{γ+1}=C;
wherein C is the sales constant, I comprises inventory levels, p comprises prices, γ is the elasticity parameter, and α is the inventory effect parameter.

8. The computer-readable medium of claim 1, wherein the demand model comprises:
S=K·I^{α}·P^{γ};
wherein S is sales units of the item selling at the store, and K is the base demand.

9. A method for estimating an elasticity and inventory effect, the method comprising:
receiving a sales condition relationship for an item at a store, the relationship comprising an elasticity parameter, an inventory effect parameter and a sales constant;
receiving a demand model for sales of the item in terms of the elasticity parameter and the inventory effect parameter and a base demand for the item selling at the store;
estimating the sales constant, the estimating comprising generating a theta parameter by taking logarithms of the sales condition relationship;
using linear regression to estimate a logarithm of the sales constant and a value of the theta parameter; and
determining a relationship between the elasticity parameter and the inventory effect parameter based on the value of the theta parameter.

10. The method of claim 9, further comprising:
eliminating either the elasticity parameter or the inventory effect parameter from the demand model based on the value of theta to generate a single variable demand model; and
using a single parameter linear regression to determine the base demand and to solve for either the elasticity parameter or the inventory effect parameter in the single variable demand model.

11. The method of claim 10, further comprising:
using the determined relationship between the elasticity parameter and the inventory effect parameter to solve for either the elasticity parameter or the inventory effect parameter.

12. The method of claim 11, further comprising:
determining a seasonality parameter based on the determined base demand, the determined elasticity parameter and the determined inventory effect parameter.

13. The method of claim 12, further comprising determining a sales forecast for sales of the item selling at the store based on the determined seasonality parameter, the determined base demand, the determined elasticity parameter and the determined inventory effect parameter.

14. The method of claim 12, further comprising determining a price markdown schedule for sales of the item selling at the store based on the determined seasonality parameter, the determined base demand, the determined elasticity parameter and the determined inventory effect parameter.

15. The method of claim 9, wherein the sales condition relationship comprises:
I^{α}p^{γ+1}=C;
wherein C is the sales constant, I comprises inventory levels, p comprises prices, γ is the elasticity parameter, and α is the inventory effect parameter.

16. The method of claim 9, wherein the demand model comprises:
S=K·I^{α}·P^{γ};
wherein S is sales units of the item selling at the store, and K is the base demand.

17. A retail pricing optimization system comprising:
a processor;
a memory storing instruction modules coupled to the processor;
the processor receiving a sales condition relationship for an item at a store, the relationship comprising an elasticity parameter, an inventory effect parameter and a sales constant;
the processor receiving a demand model for sales of the item in terms of the elasticity parameter and the inventory effect parameter and a base demand for the item selling at the store;
an estimating module for estimating the sales constant, the estimating comprising generating a theta parameter by taking logarithms of the sales condition relationship;
the estimating module using linear regression to estimate a logarithm of the sales constant and a value of the theta parameter; and
the estimating module determining a relationship between the elasticity parameter and the inventory effect parameter based on the value of the theta parameter; and
a pricing module that determines optimized pricing based on the elasticity parameter and the inventory effect parameter.

18. The system of claim 17, the estimating module further comprising:
eliminating either the elasticity parameter or the inventory effect parameter from the demand model based on the value of theta to generate a single variable demand model; and
using a single parameter linear regression to determine the base demand and to solve for either the elasticity parameter or the inventory effect parameter in the single variable demand model.

19. The system of claim 18, the estimating module further comprising:
using the determined relationship between the elasticity parameter and the inventory effect parameter to solve for either the elasticity parameter or the inventory effect parameter.

20. The system of claim 19, the estimating module further comprising:
determining a seasonality parameter based on the determined base demand, the determined elasticity parameter and the determined inventory effect parameter.
